(19) United States
(12) Patent Application Publication
(10) Pub. No.: US 2006/0263039 A1
(43) Pub. Date: Nov. 23, 2006

(54) Method and apparatus for monitoring macro range of environment based on reference frames comparison

(76) Inventor: Chien-Cheng Chiang, Taipei (TW)

Correspondence Address: HARNESS, DICKEY & PIERCE, P.L.C., P.O. BOX 8910, RESTON, VA, 20195, US

(21) Appl. No.: 11/150,194

(22) Filed: Jun. 13, 2005

(30) Foreign Application Priority Data
May 20, 2005 (TW) 94116618

(51) Int. Cl. H04N 5/91

(52) U.S. Cl. 386/68

(57) ABSTRACT

A method and an apparatus for monitoring macro environment, which achieves a real-time monitoring of a macro environment through retrieving the macro environment into more than one reference frame and comparing them with a retrieving frame by utilizing a video-retrieving device of a computer (PC camera). When the variations of the retrieving frame relative to the reference frames are beyond a preset threshold value of variation rate, the computer sends out a controlling signal to control the actuation of an alerting device, storing device or network communication device, etc. Through the monitoring method, the problem of view angle limitation existing in previous video-retrieving devices can be effectively resolved, and the real-time monitoring of a macro environment can be performed.

### BACKGROUND OF THE INVENTION

1. Field of Invention

The present invention relates to macro environment monitoring, and in particular to macro environment monitoring by applying a video-retrieving device of a computer, and can be driven and controlled by a computer executable program in order to make comparisons based on reference frames.

2. Related Art

It is an existing trend to install video-retrieving devices onto computers to provide various video-related applications.

A common application is to use the video-retrieving device as a web cam after connecting it to the Internet. However, as the consciousness of environment safety rises increasingly, many people begin to apply the video-retrieving devices installed on computers to monitor the surrounding environment.

The usual environment monitoring in the past is mainly achieved by professional photographic monitoring devices combined with computer executable programs, the primary technique of which is comparing each characteristic of picture through the video pictures retrieved by the photographic monitoring devices, determining whether something unusual of the environment occurs or not from the video pictures by referencing the variations in the video pictures retrieved successively through the computer executable program, and then providing a necessary environment monitoring alert.

However, because the hardware part of the professional photographic monitoring system is very expensive, not all the people can afford it. Accordingly, it becomes the optimum alternative solution for more and more people to replace the professional photographic monitoring devices with the relatively inexpensive video-retrieving devices of computers in order to achieve the environment monitoring.

However, there exists innate limitation in the video-retrieving devices of conventional computers can be found from U.S. Pat. No. 6,813,372, i.e., the view angle limitation. Generally speaking, such video-retrieving devices can retrieve video pictures with view angles in the range of about ±50 degrees, so the environment beyond ±50 degrees may become the dead angle of safety in the environment monitoring, which results in negligence in the environment monitoring, especially in the application of macro environment monitoring.

In order to overcome the defect mentioned above, the user has to set several video-retrieving devices for an overall security consideration, therefore the consumption of the overall computer resource is remarkably high.

Therefore, all the pursuers in the related art are making efforts to solve this problem: how to effectively utilize computer executable programs to drive and control video-retrieving devices of computers, and take better comparing logics through the computer executable programs to enable the video-retrieving devices of computers to achieve monitoring on a macro range of environment and improve the effect of environment monitoring.

### SUMMARY OF THE INVENTION

Therefore, the present invention provides a method and relates apparatus for macro environment monitoring that makes comparisons based on reference frames.

Its primary technique is that it can achieve the purpose of macro environment monitoring through retrieving the macro environment into more than one reference frame and then compare them with more than one corresponding retrieving frame, retrieved subsequently by utilizing a computer executable program, to drive and control a video-retrieving device of a computer (PC camera).

The whole macro environment monitoring method that makes comparisons based on reference frames includes the following steps:

First, carrying out the procedure of initialization and collecting reference frames. At the beginning, a retrievable reference frame range of a video-retrieving device is initially set while a threshold value of variation rate and a condition value of updating are created, then the video-retrieving device is driven into a first retrieving position, and along a first retrieving direction, the video-retrieving device is driven to sequentially retrieve more than one reference frame with the reference frame range for storage, which are to be used in the subsequent comparisons.

Second, carrying out the comparing procedure. When the video-retrieving device reaches a second retrieving position, what is performed, is: reverse retrieving comparison. At this time, along a second retrieving direction, the video-retrieving device is driven to sequentially retrieve more than one reverse retrieving frame with the reference frame range. Before the video-retrieving device has reached the first retrieving position, the reverse retrieving frame retrieved each time is compared with the reference frame of the corresponding position, so as to determine the relationship between the variation between the retrieving frame and the reference frame and the threshold value of variation rate.

When the video-retrieving device reaches the first retrieving position, what is performed, is: forward retrieving comparison. At this time, along the first retrieving direction, the video-retrieving device is driven to sequentially retrieve more than one forward retrieving frame with the reference frame range. Before the video-retrieving device has reached the second retrieving position, the forward retrieving frame retrieved each time is compared with the reference frame of the corresponding position, so as to determine the relationship between the variation of the retrieving frame and the reference frame and the threshold value of variation rate.

The above-mentioned comparing process will be carried out continuously and circularly until the condition value of updating that has been set is reached. Then, the reference frame will be updated in order to ensure the accuracy and efficiency for the whole macro environment monitoring.

When a variation between the retrieving frame and the reference frame is found during the comparing, and the variation has exceeded the threshold value of variation rate that has been set, the computer will send out a controlling signal for controlling the actuation of an alerting device, storing device, network communication device, etc.

The macro environment monitoring method that makes comparisons based on reference frames of this invention can be achieved by changing the conventional environment-monitoring mode into the mode of monitoring individual reference frames. Therefore, not only can the macro environment monitoring be achieved, but also the efficiency and effect of environment-monitoring can be improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus is not limitative of the present invention, wherein:

FIG. 1 is the schematic diagram of the operation of the present macro environment monitoring method that makes comparisons based on the reference frames;

FIG. 2a through FIG. 2c are flow charts of the operation of the present macro environment monitoring method that makes comparison based on the reference frames;

FIG. 3 illustrates the layout of apparatus to the invention; and

FIG. 4 is the flow chart of FIG 3.

### DETAILED DESCRIPTION OF THE INVENTION

The present invention provides a method for macro environment monitoring, which is mainly applied in the computer with a video-retrieving device. The method achieves macro environment monitoring by making comparisons of retrieving reference frames 40 and retrieving frames (including reverse retrieving frames 50 and forward retrieving frames 60) through utilizing a computer executable program, to drive and control the video-retrieving device.

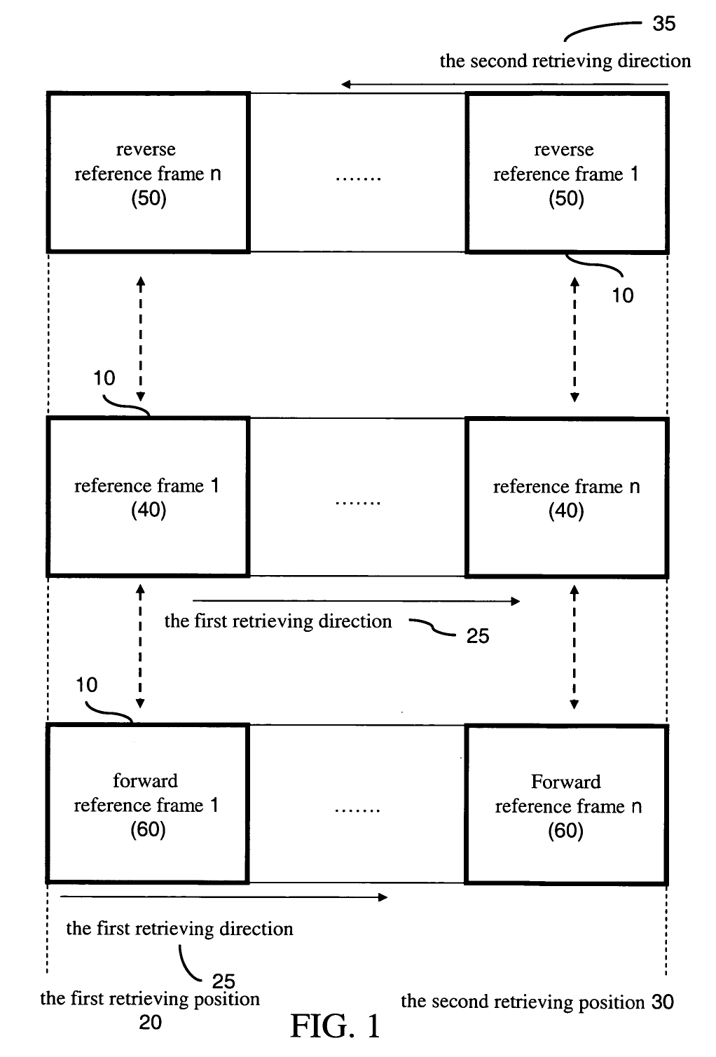

FIG. 1 is used to illustrate the schematic diagram of operation of this invention, and the operation concept described is generally as follows:

First, the video-retrieving device is driven by the computer executable program to collect and store a succession of reference frames 40 for use as a basis of reference in the subsequent comparisons.

First refer to the middle part of FIG. 1. It shows the operation diagram of retrieving the reference frames, where the video-retrieving device will, under the control of the computer executable program, collect and store the reference frame 40 along a first retrieving direction 25 starting from a first retrieving position 20, until the video-retrieving device moves into a second retrieving position 30. The actual size of each retrieved reference frame 40, i.e., reference frame range 10, is the same as the size of the largest picture the video-retrieving device can retrieve each time. Meanwhile, the number of the stored reference frames 40 can vary depending on the different ranges of horizontal, vertical or curved movement and the different sizes of reference frames 10 of various video-retrieving devices.

After the completion of storing the reference frames 40 of the whole environment, the retrieving and comparing procedure of retrieving frames may be started. Now refer to the upper part of FIG. 1. Since the video-retrieving device is in the second retrieving position 30, the retrieving and comparing procedure of retrieving frames will be carried out along a second retrieving direction 35 starting from the second retrieving position 30, where, because the second retrieving direction 35 is just opposite to the first retrieving direction 25, this retrieving and comparing procedure may also be called as ‘reverse retrieving and comparing’ procedure, wherein each retrieving frame that has been retrieved can also be called ‘reverse retrieving frame’ 50, of which the size is equal to said reference frame range 10.

The whole reverse retrieving and comparing procedure is performed in a manner that the reference frames 40 are compared with the reverse retrieving frames 50 in the corresponding positions one by one. Once a retrieving comparison is completed, a real-time determination, whether a variation beyond expectation is generated or not, may be made, and only after then will the next retrieving comparison proceed until the video-retrieving device returns to the first retrieving position 20. Because it is a reverse retrieving and comparing procedure, the relationship of corresponding positions in the entire retrieval of the reverse retrieving frames 50 and reference frames 40 for comparisons can be expressed by the following expressions:
(Reverse retrieving frame 1, reference frame n), (reverse retrieving frame 2, reference frame n-1) . . . (reverse retrieving frame n-1, reference frame 2) and (reverse retrieving frame n, reference frame 1).

Refer to the lower part of FIG. 1 when the video-retrieving device is in the first retrieving position 20. The video-retrieving device will proceed with the retrieving and comparing procedure along the first retrieving direction 25, where, because the first retrieving direction 25 is just the same as the retrieving direction of reference frames 40 that have been stored, this retrieving and comparing procedure may be called a ‘forward retrieving and comparing’ procedure, wherein each retrieving frame that has been retrieved can also be called a ‘forward retrieving frame’ 60, of which the size is equal to said reference frame range 10.

The whole forward retrieving and comparing procedure is similar to said reverse retrieving and comparing procedure, while the difference is, that because it is a forward retrieving and comparing procedure, the relationship of corresponding positions in the entire retrieval of the forward retrieving frames 60 and reference frames 40 can be changed to the following manner:
(forward retrieving frame 1, reference frame 1), (forward retrieving frame 2, reference frame 2) . . . (forward retrieving frame n-1, reference frame n-1) and (forward retrieving frame n, reference frame n).

When a variation between the reference frame 40 and the retrieving frame (including the reverse retrieving frame 50 and forward retrieving frame 60) is found during any retrieving and comparing process, and the variation degree has exceeded the preset threshold value of variation rate, the computer will send out a controlling signal for controlling the actuation of an alerting device, storing device, network communication device, etc, and thereby the safety of the environment that is monitored is ensured in time.

The parts related to the first retrieving position 20, the first retrieving direction 25, the second retrieving position 30 and the second retrieving direction 35 are primarily predefined by the computer executable program, onto which the present invention will not put any limitation. The relevant illustration is given as follows:

In fact, both the first retrieving position 20 and the second retrieving position 30 are used to represent the two ends of the maximum moving range of the video-retrieving device. It is assumed that the first retrieving position 20 represents the leftmost end of the range within which the video-retrieving device can move, and then the second retrieving position 30 represents the rightmost end of the range, within which the video-retrieving device can move. Accordingly, the first retrieving direction 25 represents the direction from the first retrieving position 20 to the second retrieving position 30 (i.e., from left to right), and the second retrieving direction 35 represents the direction from the second retrieving position 30 to the first retrieving position 20 (i.e., from right to left).

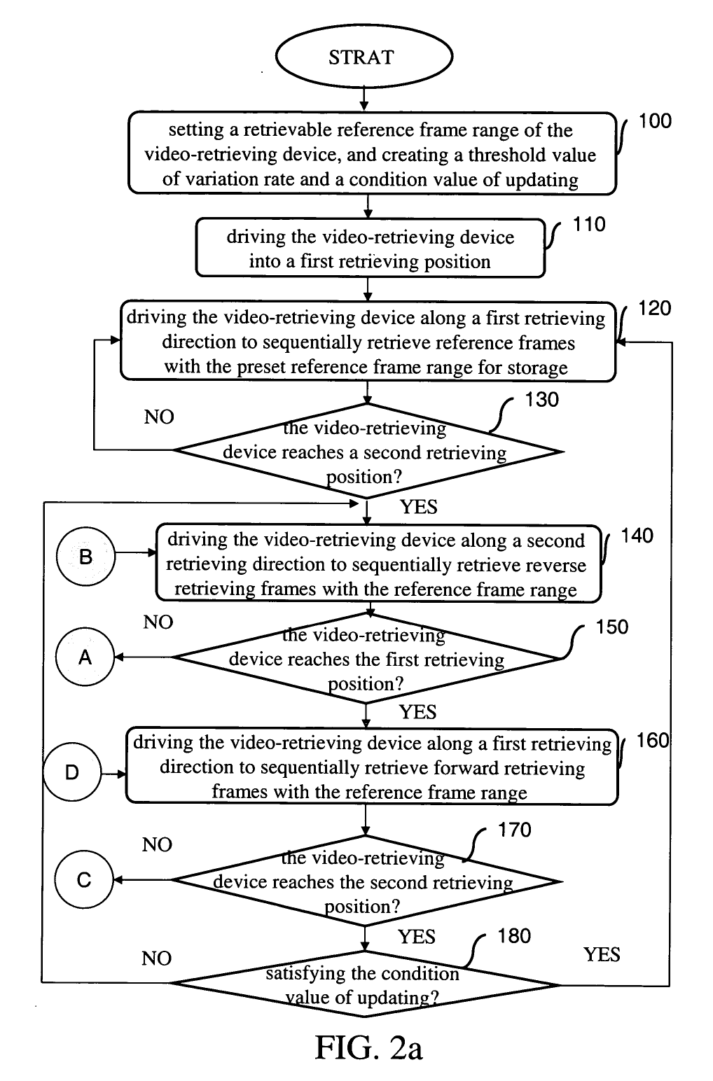

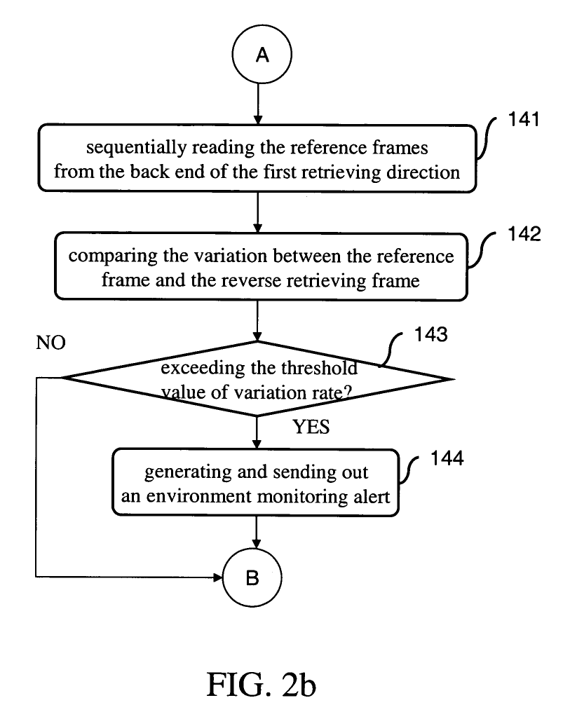

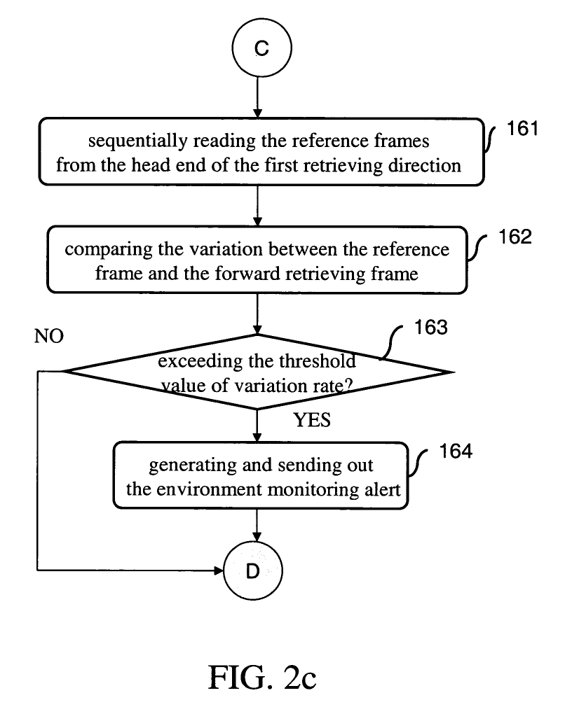

FIG. 2a through FIG. 2c are flow charts of operation of the present method, which are used to further illustrate the detailed process steps of the present method.

First, the initialization procedure of the computer executable program and video-retrieving devices is carried out. As for the parts related to the computer executable program, they include setting the retrievable reference frame range 10 of the video-retrieving device (the same size as the largest picture that the video-retrieving device can retrieve each time), and creating the threshold value of variation rate and condition value of updating (Step 100).

The condition value of updating is used to decide the time for updating the stored reference frames 40. The condition value of updating may be a predetermined updating time, at which the procedure of updating the reference frames 40 will be performed. Otherwise, the condition value of updating may also be a predetermined number of arrivals, that is, when the video-retrieving device moves into a certain retrieving position for certain times, the procedure of updating the reference frames 40 is started. The condition value of updating may also be a predetermined number of comparisons, that is, when the retrieving and comparing has been performed by certain times, the procedure of updating the reference frames 40 is started. This part is not limited anyway in the present invention. As for the initialization of the video-retrieving device, the video-retrieving device is driven into the first retrieving position 20 by the computer executable program (Step 110).

After the completion of initialization, along the first retrieving direction 25, the video-retrieving device is driven to sequentially retrieve more than one reference frame 40 with the preset reference frame range 10 for storage (Step 120), which will be used as the basis of reference for the following comparisons. The whole procedure of retrieving the reference frames will continue until the video-retrieving device moves into the second retrieving position 30, during which the computer executable program may continuously determine whether the video-retrieving device has reached the second retrieving position 30 or not (Step 130). If not, Step 120 will be continued so as to retrieve the reference frames 40.

When the video-retrieving device has reached the second retrieving position 30, said reverse retrieving and comparing procedure is started. At this time, along the second retrieving direction 35, the video-retrieving device is driven by the computer executable program to retrieve more than one reverse retrieving frame 50 with the preset reference frame range 10 (Step 140). After one reverse retrieving frame 50 is retrieved each time, the computer executable program will determine whether the first retrieving position 20 has been reached or not (Step 150). If not, it proceeds to Step A of FIG. 2b, and the procedure of reverse retrieving and comparing is performed.

Step A in FIG. 2b includes the following process steps in detail. First, because it is a reverse retrieving and comparing procedure, the first reverse retrieving frame 50 must be compared with the last reference frame 40. Therefore, the stored reference frames 40 will be read sequentially from the backmost end of the first retrieving direction 25 for comparisons (Step 141). Take FIG. 1 for example. The comparison is made between (retrieving frame 1, reference frame n). The variations between the reference frames 40 and the reverse retrieving frames 50 are compared (Step 142). The manner of comparing can be achieved by conventional techniques, for example: comparing the variation of color, brightness and so on. Then it is determined whether the variation between the two exceeds the preset threshold value of variation rate or not (Step 143). If so, an environment-monitoring alert is generated and sent out according to the preset manner of alerting (Step 144). The process returns to Step 140 in FIG. 2a through Step B after one retrieving and comparing and the video-retrieving device continues to retrieve the next reverse retrieving frame 50 for comparison. Contrarily, if the variation does not exceed the preset threshold value of variation rate, Step 144 of sending out an environment monitoring alert is skipped and directly proceeds to Step B.

Before the video-retrieving device has reached the first retrieving position 20, the computer executable program may compare the reverse retrieving frame 50, retrieved each time with the reference frame 40 in the corresponding position, in order to determine the relationship between the variation of the reverse retrieving frame 50, the reference frame 40 and the threshold value of the variation rate, for deciding whether to send out a environment monitoring alert or not.

Therefore, the above Step 140 and Step 150 will be continued until the video-retrieving device reaches the first retrieving position 20. Then, said forward retrieving and comparing procedure follows. At this time, along the first retrieving direction 25, the video-retrieving device is driven by the computer executable program to retrieve more than one forward retrieving frame 60 with the preset reference frame range 10 (Step 160). After one forward retrieving frame 60 is retrieved each time, the computer executable program will determine whether the second retrieving position 30 has been reached or not (Step 170). If not, it proceeds to Step C of FIG. 2c, and the procedure of forward retrieving and comparing is performed.

Step C in FIG. 2c includes the following process steps in detail. First, because it is a forward retrieving and comparing procedure, the first forward retrieving frame 60 must be compared with the first reference frame 40. Therefore, the stored reference frames 40 will be read sequentially from the headmost end of the first retrieving direction 25 for comparisons (Step 161). Also take FIG. 1 for example. The comparison is made between forward retrieving frame 1 and reference frame 1. The variations between the reference frames 40 and the forward retrieving frame 60 are compared (Step 162). Then it is determined whether the variation between the two exceeds the preset threshold value of variation rate or not (Step 163). If so, an environment-monitoring alert is generated and sent out according to the preset manner of alerting (Step 164). The process returns to Step 160 in FIG. 2a through Step D after one retrieving and comparing, and the video-retrieving device continues to retrieve the next forward retrieving frame 60 for comparison. Contrarily, if the variation does not exceed the preset threshold value of variation rate, Step 164 of sending out an environment-monitoring alert is skipped and directly proceeds to Step D.

Before the video-retrieving device has reached the second retrieving position 30, the computer executable program may compare the forward retrieving frame 60, retrieved each time with the reference frame 40 in the corresponding position, in order to determine the relationship between the variation between the forward retrieving frame 60, the reference frame 40 and the threshold value of variation rate, thereby deciding whether an environment-monitoring alert should be sent out or not.

Step 140 through Step 170 will be carried out continuously and circularly. However, in order to ensure the quality of the whole environment-monitoring, it is necessary to update the reference frames 40 stored previously before the particular condition of updating is reached. Therefore, the computer executable program will determine whether said condition value of updating is satisfied or not after Step 170 (Step 180). If the value is satisfied, the process returns to Step 120 to retrieve reference frames 40 gain, otherwise Step 140 through Step 170 will be continued.

In fact, the part of determining the time point with respect to the condition value of updating in step 180 can be adjusted according to various developing conditions of different computer executable programs, to comply with the need for environment monitoring. The present invention has no limitation in this part.

As for the alerting, it can be handled according to actual needs. For example, being connected to an e-mail server, the computer executable program can send e-mails as environment monitoring alerts, or it can make environment monitoring alerts in brief message after being connected to a brief message server. Otherwise, the computer executable program itself can display the environment monitoring by displaying window messages on the computer screen. The present invention has no limitation in this part either.

Therefore, by the monitoring method of this invention, the problem of view angle limitation that exists in the video-retrieving device can be efficiently resolved, and the real-time monitoring on macro environment can be achieved. What's more, the real-time environment monitoring can be achieved in a more precise manner.

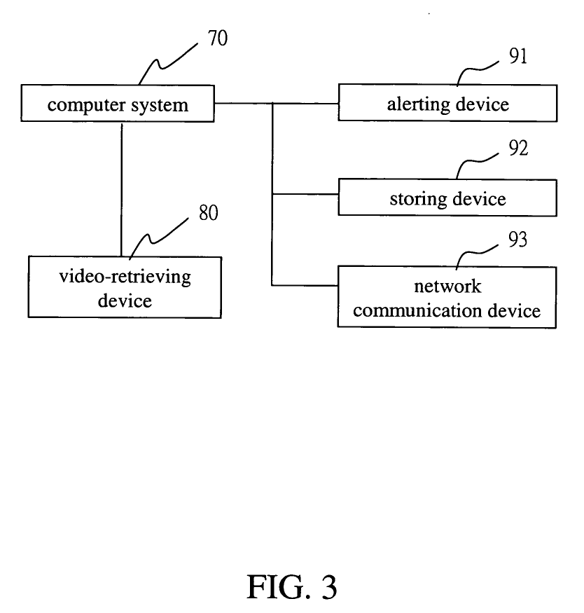

FIG. 3 illustrates the monitoring apparatus for macro environment of the present invention, which includes a computer system 70 and a video-retrieving device 80 connected to the computer system 70. The computer system 70 can control the video-retrieving device 80 to move back and forth in the same path. Moreover, the video-retrieving device 80 can retrieve at least N reference frames in a forward retrieving direction, and at least M retrieving frames in a reverse retrieving direction, wherein these N reference frames and the M retrieving frames are of the same number and size, and the location of each of the M retrieving frames is corresponding to that of one of the N reference frames. In addition, the video-retrieving device 80 can also retrieve, in a forward retrieving direction, at least N retrieving frames, of which the sizes and locations are corresponding to those of the N reference frames in the forward retrieving direction. Each retrieving frame is compared with the reference frame in a corresponding position, and if the variation therein exceeds a threshold value, it represents a varied retrieving frame, and then the computer system 70 generates a controlling signal to thereby control one of an alerting device 91, a storing device 92, a network communication device 93, or the combination thereof.

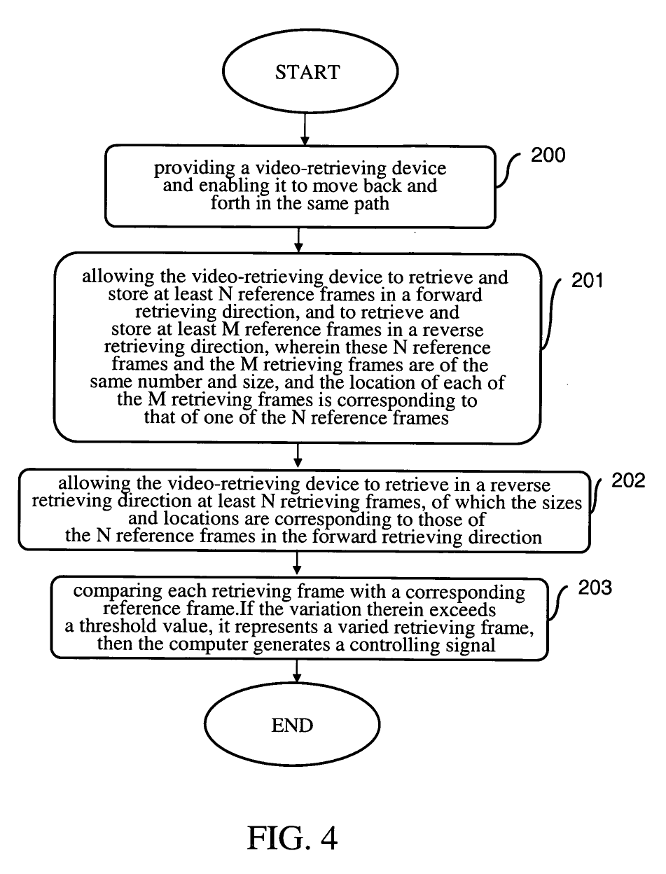

FIG. 4 illustrates the flow chart corresponding to FIG. 3. The environment monitoring method involving a computer system includes: providing a video-retrieving device and enabling it to move back and forth in the same path (Step 200); allowing the video-retrieving device to retrieve and store at least N reference frames in a forward retrieving direction, and to retrieve and store at least M reference frames in a reverse retrieving direction, wherein these N reference frames and the M retrieving frames are of the same number and size, and the location of each of the M retrieving frames is corresponding to that of one of the N reference frames (Step 201). Further, allowing the video-retrieving device to retrieve, in a forward retrieving direction, at least N retrieving frames, of which the sizes and locations are corresponding to those of the N reference frames in the forward retrieving direction (Step 202). Then, comparing each retrieving frame with a corresponding reference frame, and if the variation therein exceeds a threshold value, it represents a varied retrieving frame. Then the computer generates a controlling signal (Step 203) to thereby control one of an alerting device, a storing device and a network communication device, or the combination thereof.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for monitoring macro range of environment, in which the macro range of environment monitoring is performed by utilizing a computer executable program to drive and control a video-retrieving device of computer, said method comprises the following steps:
setting a retrievable reference frame range of the video-retrieving device, and creating a threshold value of variation rate and a condition value of updating;
driving the video-retrieving device into a first retrieving position;
along a first retrieving direction, driving the video-retrieving device to sequentially retrieve more than one reference frame with the reference frame range for storage;
when the video-retrieving device reaches a second retrieving position, along a second retrieving direction, driving the video-retrieving device to sequentially retrieve more than one reverse retrieving frame with the reference frame range;
before the video-retrieving device has reached the first retrieving position, comparing the reverse retrieving frame retrieved each time with the reference frame of the corresponding position, so as to determine the relationship between the variation between the retrieving frame and the reference frame and the threshold value of variation rate;
when the video-retrieving device reaches the first retrieving position, along the first retrieving direction, driving the video-retrieving device to sequentially retrieve more than one forward retrieving frame with the reference frame range; and
before the video-retrieving device has reached the second retrieving position, comparing the forward retrieving frame retrieved each time with the reference frame of the corresponding position, so as to determine the relationship between the variation between the retrieving frame and the reference frame and the threshold value of variation rate;
wherein, when the method satisfies the condition value of updating, repeating the step of retrieving each of the reference frames for updating the storage;
wherein, when the variation between the reverse retrieving frame and the reference frame or the variation between the forward retrieving frame and the reference frame exceeds the threshold value of variation rate, an environment-monitoring alert will be generated and sent out.

2. The environment monitoring method of claim 1, in which the reference frame range indicates the size of the largest picture that can be retrieved by the video-retrieving device each time.

3. The environment monitoring method of claim 1, in which the condition value of updating indicates a predetermined updating time.

4. The environment monitoring method of claim 1, in which the condition value of updating indicates a predetermined number of arrivals that the video-retrieving device reaches the first retrieving position.

5. The environment monitoring method of claim 1, in which the condition value of updating indicates a predetermined number of comparisons.

6. The environment monitoring method of claim 1, in which when the first retrieving position controls the video-retrieving device to the leftmost end, the first retrieving direction is from left to right, and the second retrieving position controls the video-retrieving device to the rightmost end, and the second retrieving direction is from right to left.

7. The environment monitoring method of claim 1, in which when the first retrieving position controls the video-retrieving device to the rightmost end, the first retrieving direction is from right to left, and the second retrieving position controls the video-retrieving device to the leftmost end, and the second retrieving direction is from left to right.

8. The environment monitoring method of claim 1, in which before the video-retrieving device has reached the first retrieving position, the comparing the reverse retrieving frame retrieved each time with the reference frame of the corresponding position, so as to determine the relationship between the variation between the reverse retrieving frame and the reference frame and the threshold value of variation rate further includes the following steps:
sequentially reading the reference frames from the back end of the first retrieving direction;
comparing the variation between the reference frame and the reverse retrieving frame; and
when the variation exceeds the threshold value of variation rate, generating and sending out an environment-monitoring alert.

9. The environment monitoring method of claim 1, in which before the video-retrieving device has reached the second retrieving position, the comparing the forward retrieving frame retrieved each time with the reference frame of the corresponding position, so as to determine the relationship between the variation between the forward retrieving frame and the reference frame and the threshold value of variation rate further includes the following steps:
sequentially reading the reference frames from the head end of the first retrieving direction;
comparing the variation between the reference frame and the forward retrieving frame; and
when the variation exceeds the threshold value of variation rate, generating and sending out an environment-monitoring alert.

10. The environment monitoring method of claim 1, in which when the variation between the reverse retrieving frame and the reference frame or the variation between the forward retrieving frame and the reference frame exceeds the threshold value of variation rate, the generating and sending out an environment-monitoring alert further includes the step of sending out an e-mail through an e-mail server.

11. The environment monitoring method of claim 1, in which when the variation between the reverse retrieving frame and the reference frame or the variation between the forward retrieving frame and the reference frame exceeds the threshold value of variation rate, the generating and sending out an environment-monitoring alert further includes the step of sending out a brief message through a brief message server.

12. The environment monitoring method of claim 1, in which when the variation between the reverse retrieving frame and the reference frame or the variation between the forward retrieving frame and the reference frame exceeds the threshold value of variation rate, the generating and sending out an environment-monitoring alert further includes the step of sending out a window message through the computer executable program.

13. A macro range of environment monitoring apparatus, comprising:
a computer system; and
a video-retrieving device connected to the computer system;
wherein the computer can control the video-retrieving device to move back and forth in the same path;
wherein the video-retrieving device can retrieve at least N reference frames in a forward retrieving direction;
wherein the video-retrieving device can retrieve at least M retrieving frames in a reverse retrieving direction;
wherein these N reference frames and the M retrieving frames are of the same number and size, and the location of each of the M retrieving frames is corresponding to that of one of the N reference frames;
wherein the retrieving device can also retrieve in a forward retrieving direction at least N retrieving frames, and the sizes and locations of which are corresponding to those of the N reference frames in the forward retrieving direction;
wherein each of the retrieving frames is compared with the reference frame in a corresponding position, and if the variation therein exceeds a threshold value, it represents a varied retrieving frame, and then the computer generates a controlling signal.

14. The monitoring apparatus of claim 13, in which the controlling signal can at least control the actuation of any one of an alerting device, a storing device and a network communication device.

15. A method for environment monitoring involving to a computer, comprising:
providing a video-retrieving device and enabling it to move back and forth in the same path;
allowing the video-retrieving device to retrieve and store at least N reference frames in a forward retrieving direction, and to retrieve and store at least M reference frames in a reverse retrieving direction; wherein these N reference frames and the M retrieving frames are of the same number and size, and the location of each of the M retrieving frames is corresponding to that of one of the N reference frames;
allowing the video-retrieving device to retrieve in a forward retrieving direction at least N retrieving frames, the sizes and locations of which are corresponding to those of the N reference frames in the forward retrieving direction; and
comparing the retrieving frame with a corresponding reference frame, and if the variation therein exceeds a threshold value, it represents a varied retrieving frame, and then the computer generates a controlling signal.

16. The monitoring device of claim 15, in which the controlling signal can at least control the actuation of any one of an alerting device, a storing device and a network communication device or the combination thereof.
